(19) United States
(12) Patent Application Publication
(10) Pub. No.: US 2011/0163872 A1
(43) Pub. Date: Jul. 7, 2011

(54) SYSTEM, DEVICE AND METHOD FOR EMERGENCY PRESENCE DETECTION

(75) Inventors: Willem Franke Pasveer, Dordrecht (NL); Roger Peter Anna Delnoij, Lommel (BE)

(73) Assignee: KONINKLIJKE PHILIPS ELECTRONICS N.V., EINDHOVEN (NL)

(21) Appl. No.: 13/062,027

(22) PCT Filed: Sep. 1, 2009
(86) PCT No.: PCT/IB2009/053808

§ 371 Date: Mar. 3, 2011

Related U.S. Application Data
(60) Provisional application No. 61/095,685, filed on Sep. 10, 2008.

(51) Int. Cl. G08B 1/08

(52) U.S. Cl. 340/539.12

(57) ABSTRACT

A detection device and method includes a transducer array (20) located at a designated area and configured to perform an ultrasonic sweep of the area in response to a trigger event. The transducer array is capable of determining a presence of a live being (16) in the area in accordance with the ultrasonic sweep. A power supply (21) is coupled to the transducer array to provide power to the transducer array and to enable the ultrasonic sweep in a power failure. A transmitter is configured to transmit a result of the ultrasonic sweep to provide a determination of the presence of a live being and the live being's location in the area to personnel responding to an event.

This disclosure relates to presence detection, and more particularly to a system, method and device configured to scan an area during an emergency or other event to detect the presence of humans or animals in the area.

During emergency situations, for example, when there is a fire in a building, an alarm is triggered by smoke detectors. However, the presence of people in rooms of the building may be difficult to trace or detect. This may be due to the lack of visibility in the presence of smoke or fire, the people may be unconscious, and/or the people may be trapped. In the fire situation, fire fighters have to enter the building and search each room for people that may still be present in the building. It would be advantageous, if information about a number of people and their location in the building were available to rescue workers at the time of response.

In accordance with the present principles, a presence detection system, device and method are provided which can easily be integrated in a current emergency lighting or emergency power system. In one embodiment, a device is integrated in a smoke detector or the like. The presence detection is able to scan a room for the presence of people (or pets) even when the room is filled with smoke.

In one embodiment, a transducer array is provided which is capable of scanning an assigned area and reporting to a central station, storage memory or a real-time console or portable device whether people or pets are in an area such as a room. In useful embodiments, a number of beings and their locations are provided. This information is particularly advantageous in emergency situations, where fire fighters or rescue workers need contemporaneous information about human or pet presence in an area. The present principles provide a low energy solution capable of saving lives and preventing injury to rescue workers.

A detection device and method includes a transducer array configured to perform an ultrasonic sweep of an area. The transducer array is capable of determining a presence of a live being in a designated area. An emergency power supply is coupled to the transducer array to provide power to the transducer array in a power failure. An output device is configured to receive a result of the ultrasonic sweep to provide a determination of the presence of a live being and the live being's location in the area to personnel responding to an event. In one embodiment, the detection device may be provided in or on a fire or smoke detector device to enhance the capabilities of such a device.

A detection device and method includes a transducer array located at a designated area and configured to perform an ultrasonic sweep of the area in response to a trigger event. The transducer array is capable of determining a presence of a live being in the area in accordance with the ultrasonic sweep. A power supply is coupled to the transducer array to provide power to the transducer array and to enable the ultrasonic sweep in a power failure. A transmitter is configured to transmit a result of the ultrasonic sweep to provide a determination of the presence of a live being and the live being's location in the area to personnel responding to an event.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

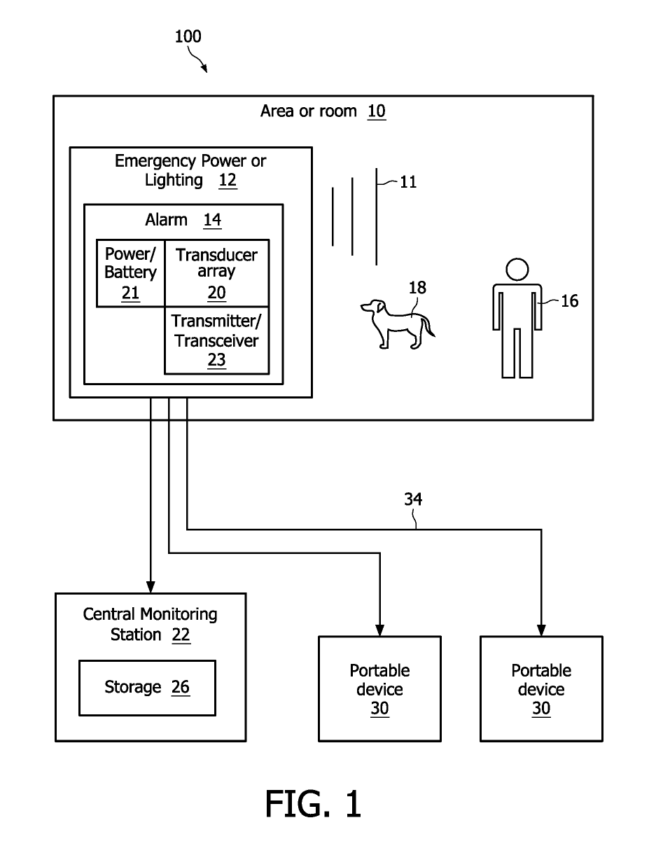

FIG. 1 is a block diagram showing a device/system for presence detection in accordance with one illustrative embodiment;

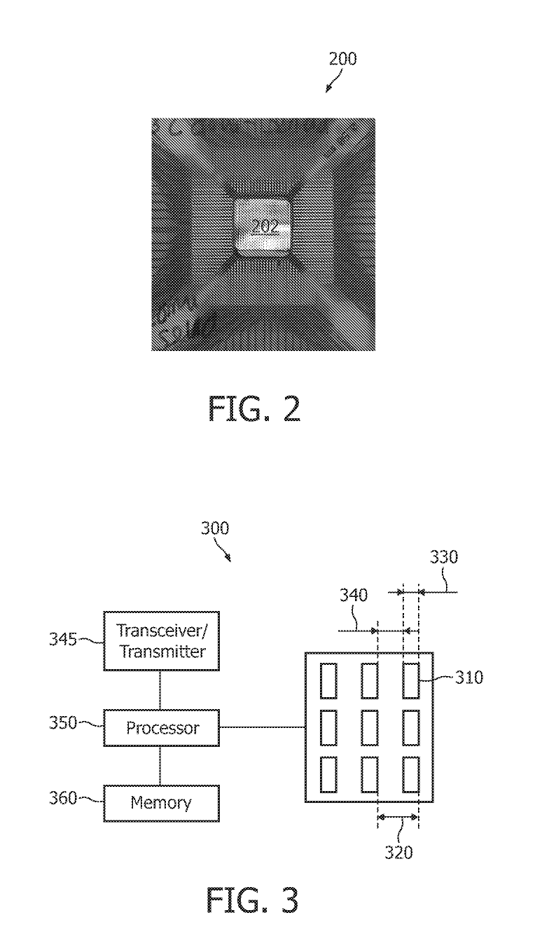

FIG. 2 is a diagram showing a transducer device for monitoring ultrasonic energy for determining whether living beings are present in an area;

FIG. 3 is a block diagram showing an array of transducers according to one embodiment;

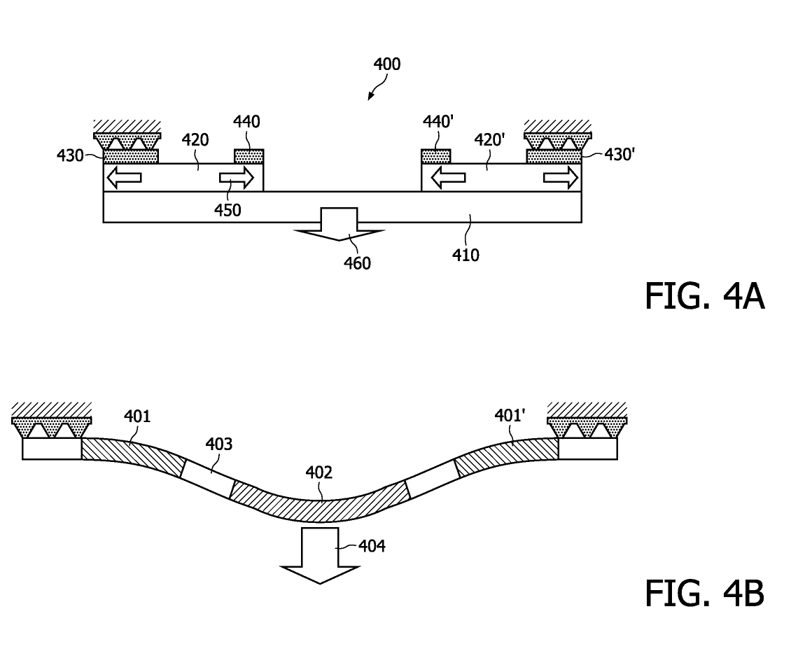

FIGS. 4A-4B show a transducer having electrodes on one side of a piezoelectric material according to one embodiment of the present system; and

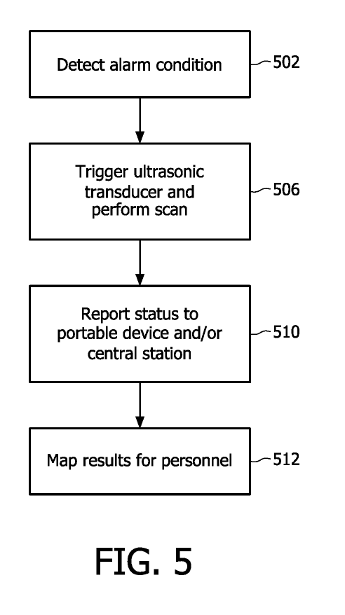

FIG. 5 is a block/flow diagram showing a system/method for detecting living presence using ultrasonic waves.

The present disclosure describes a presence detection system, device and method in terms of an emergency situation in a room or building. It should be understood that such an application is merely illustrative, and the present invention finds utility in a plurality of applications and scenarios. For example, the presence detection system may be employed on boats or ships, in vehicles, in mining operations or other scenarios where people or pets need to be located in emergency situations. In one embodiment, a presence detection device is implemented on a semiconductor chip, printed circuit board or other substrate. The device is configured to consume a minimal amount of power and may be easily deployed without being obtrusive.

In particularly useful embodiments, a device is presented which is able to detect persons in a room while the room is filled with smoke as in the case of a fire in a building. When a fire alarm in the building is activated by smoke detection sensors, the device is triggered to become active and perform an ultrasound detection sweep through the room to scan for persons still present in the room. The result of the measurement is communicated to a central display such that rescue workers, upon arrival, can easily locate people or pets that may be remaining in the room or building. Communication may be provided either wirelessly or via a wired link.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown. The elements depicted in the FIGS. may be implemented in various combinations of hardware and provide functions which may be combined in a single element or multiple elements.

Referring now to the drawings in which like numerals represent the same or similar elements and initially to FIG. 1, a system 100 provides emergency detection of humans 16 and pets 18 in a room or area 10. The area 10 may include a room in a building, a vehicle, or other monitored area. In one embodiment, a transducer array 20 is connected to an emergency detection or alarm system 14. The emergency detection system 14 may include one or more of a fire detector, a smoke detector, a carbon monoxide detector, a burglar alarm or any other detection system. When the emergency detection system 14 is triggered, the transducer array 20 begins to scan the area 10 looking for people 16 or pets 18 that may be present. Scanning may also be intermittently performed or constantly performed.

The transducer array 20 preferably includes an array of thin-film ultra-sound transducers which are able to perform a full scan of the room 10 to check for the presence of people. An illustrative example of such a thin-film ultra-sound transducer will be described below. An ultra-sonic solution is particularly useful when the room is completely filled with smoke. A reliable power supply is needed to power the transducer 20. In one embodiment, power is provided by an emergency power or lighting system 12. The transducer array 20 may be integrated with the available emergency hardware which is possible due to its very small size and low power consumption. In one embodiment, the transducer array 20 may include its own battery or back-up energy system 21 to ensure function when or if the regular power grid fails.

Since the transducer array 20 is coupled to the alarm system 14, the transducer 20 can be monitored remotely using a monitoring station 22. The monitoring station 22 may include a central station monitoring service (or other station, e.g., at the fire house, etc.) used in many alarm or emergency systems. The monitoring station 22 may include memory storage 26 to create a log of activities or events and to store the results and data from the transducer scans in one or more areas of the building. The monitoring station 22 may communicate wirelessly or over a wired connection.

In one embodiment, portable devices 30 may be employed. The portable devices 30 may be tuned to the transducer 20 or alarm system 14 output signals to provide emergency personnel an indication of whether people or pets remain inside a building. This may be implemented by employing a special signal channel 34 which is accessible by emergency personnel. Devices 30 may by the size and shape of, e.g., a cellular telephone or a GPS device and preferably include a video display on which location information or a GPS map may be displayed. To enable wireless communications, a transceiver 23 may be employed to permit, e.g., radio frequency (RF) communications between the portable device 30 and/or central station 22.

Software programs may be written to provide an appropriate interface for emergency personnel to access the scan results of transducers at a building location. In one example, a fire fighter may enter the address or use GPS data to cross-reference to an alarm or security system 14 at a given location. This may include cross-referencing a look-up table to find the communication channel that is sending information about the presence detection at a given location. In using the device 30, security protocols could permit the fire fighter access to the results of the scan to determine the presence and location of people in the building. Further, a building floor plan may be made available through the use of device 30 (or station 22). In this way, the emergency personnel would have a detailed mapping of where people are located in a building and would be able to determine ingress and egress paths.

In one embodiment, the transducer array 20 may trigger a distinctive sounding alarm when a person is present as detected by the alarm triggered scan. The distinctive sounding alarm is preferably associated with this type of application such that rescue workers can hear the audible alarm and respond. The audible alarm can lead the rescue workers to the person's location based on acoustic information alone.

The transducer 20 preferably includes an array of ultrasonic transducers which may be shaped or directed in a plurality of directions in the room 10. Ultrasonic waves 11 are omni-directional and bounce off walls, floors etc. so that a direct line of sight is not needed between a living being (16, 18) and the transducer 20. Ultrasonic waves are capable of determining density changes (areas of different densities) in the room 10 and whether these areas of different density are moving (motion sensing) by comparing a sequence of images or data. Ultrasonic technology is known in the art for other applications.

In an illustrative scenario, a fire in a building triggers a fire alarm. The fire alarm triggers the transducer array 20 to begin scanning the area 10. A person 16 or a pet 18 may be trapped or unconscious in the area 10. The scan uses ultrasonic waves to penetrate any visual impairment, such as smoke, to detect the person 16 or pet 18. If the scan discovers a person or pet, the transducer 20 responds by signaling one or more of the monitoring station 22, the portable device or devices 30 and/or sounds an audible alarm. Otherwise, the scan information may simply be stored (e.g., in remote memory 26).

Referring to FIG. 2, the transducer array 20 may include a device 200 having an array 202 of thin-film ultra-sound transducers that are connected to a microcontroller which are capable of generating ultrasonic wave and processing received presence detection signals. In one embodiment, the thin film ultrasound transducer array 202 may include, e.g., about 10-20 elements (transducers), with an element pitch of, e.g., several hundred micrometers, and a total device size in the order of about 10×10 mm. The size and dimensions given herein are for illustrative purposes, and should not be construed as limiting. It should be understood that the size of the device 200 permits ease of deployment in any alarm system, including smoke detectors that are currently standard devices employed in homes. The size and dimensions of the transducer array are preferably unobtrusive in appearance and energy efficient.

Because the device 200 has a transducer array 202, the device 200 is capable of performing a sweep or scan. Moreover, the device 200 as prototyped has shown transmit efficiency in air at a surprisingly low power consumption. In one illustrative example, for, say, a 5 Volt peak-peak power level, it is possible to cover about 2.5 meters with a few milliWatts. This can be further optimized, but is described for illustrative purposes.

Advantageously, the ultrasound device 200 can be connected to the power supply already present for the emergency lighting (which is typically compliant with the strict requirements for emergency applications). The use of this power supply will not provide any issues due to the low power consumption of the ultrasound transducer array 202. The device 200 could be integrated in the lighting hardware or connected to the hardware in a secured way. This integration or connection is simplified due to the small and flat characteristics of the device 200.

According to illustrative embodiments, a transducer and/or an array of transducers are provided which may be used, e.g., for real-time imaging in air, as well as fluid and solids. The transducers are employed for presence and/or motion detection of object(s) by using Doppler effects, for example, including inanimate and animate object(s), and for the determination of various parameters such as speed, direction of movement, location, and/or the number of the object(s). In one embodiment, the transducer is a thin-film, which comprises a membrane formed over a front substrate. A piezoelectric layer is formed over the membrane at an active portion, and peripheral portions are adjacent to the active portion. If desired, the piezoelectric layer may be patterned. A patterned conductive layer including first and second electrodes is formed over the piezoelectric layer. Further, a back substrate structure is provided having supports located at the peripheral portions adjacent the active portion. The height of the supports is greater than a combined height of the patterned piezoelectric layer and the patterned conductive layer. Many transducers may be connected to form an array, where a controller may be provided for controlling the array, such as steering a beam of the array, and processing signals received by the array, for presence or motion detection and/or imaging, for example.

Various sensors may be provided on flexible foils to form flexible sensors which may be formed into any desired shape. Further, different types of sensors or detectors may be combined or integrated into a single multi-sensor, such as a multi-sensor including combined ultrasound and pyroelectric detectors for detecting ultrasound and/or infrared signals. The sensors may be used in various applications, such as imaging (ultrasound and/or infrared (IR) imaging) as well as motion or presence detection, where the ultrasound sensor(s) does not require a line of sight for operation, in contrast to the IR sensor(s) which does require a line of sight for operation, including transmission and/or reception of ultrasound and/or IR signals.

Referring to FIG. 3, in an illustrative embodiment, thin film piezoelectric transducer arrays are used for presence and/or motion detection and the like, where FIG. 3 shows an array 300 of thin film piezoelectric transducer elements 310. The array 300 and/or each element 310 may have any size and shape. The pitch 320 of the elements 310 is selected based on application. For motion detectors, to achieve a low attenuation in air, the arrays are designed to operate at frequencies of, e.g., 50-450 KHz. To operate at these low frequencies, the element pitches 320 are approximately a few hundred micrometers to several thousand micrometers (e.g., the pitch may be between about 200 micrometers and about 4000 micrometers). The pitch 320 is the width 330 of an element plus the gap 340 that separates one element from an adjacent element.

As shown in FIG. 3, the array may be connected to a controller or processor 350 with associated electronics, such as phase shifters, delay taps, converters and the like, as described in U.S. Pat. No. 6,549,487 to Gualtieri, for control of the array and processing information received from the array 300, such as to enable electronic steering the ultrasonic beam for wider coverage and reduction or elimination of blind spots. A memory 360 may also be operatively coupled to the processor 350 for storing various data and application programs and software instructions or codes for control and operation of the array system when executed by the processor 350. The processor 350 and memory 360 may be located at or near the transducer array or located remotely from the transducer array.

Such an array of transducer 300 may be employed during a fire alarm or other emergency, the array 300 is triggered (or it may always be on) to perform a sweep to detect whether there are people (pets) present in a room or area. In principle, the array 300 would be able to see whether the people are still moving or whether they have become static based on ultrasonic waves generated and detected by the array 300. The result of the measurement will be communicated to a central board or station (see FIG. 1) where it can be easily visualized that “a person is still present in this room”. This communication can be either via a wireless interface or via a wired communication line. For a wireless application, a transceiver or at least a transmitter 345 is employed. The transmitter 345 receives the transducer information from transducer array 300 through the processor 350 and transmits the information to receiver devices (e.g., central station 22 or portable devices 30 in FIG. 1).

The processor or microcontroller 350 provides signal processing to the transceiver 345 compliant with, e.g., the Zigbee standard, but any other protocol may be employed. The transceiver 345 is triggered to wake-up from a sleep state or from standby, to send a message with the needed content. It is preferable that processor 350, transducer array 300 and transceiver 345 have a power consumption as low as possible, so low power components are preferably employed.

The information will be valuable for a fire brigade when arriving at the building. Advantageously, in one embodiment, the ultrasound transducer array 300 may be directly integrated into a smoke detector, a carbon monoxide detector, a burglar alarm or the like to provide an integrated solution. In particularly useful embodiments, a sensor device is added to an emergency lighting system to have knowledge about people still present in a room of a building. In another application, the ultrasound transducers may be mounted in a detector/sensor in a home environment.

As one example how such a thin film ultrasound transducer is formed, a sensor 400 is provided, as shown in FIG. 4A where, electrodes 430, 440 and 430′, 440′ are processed on the same side of the piezoelectric thin film, and the elements operate in a poling direction parallel to the plane of the transducer. In particular, the in-plane electric field between a pair of electrodes 430, 440, and 430′, 440′, which may be inter-digitated, causes longitudinal stress oscillation in the plane of the piezoelectric thin film that in turn leads to a flexural oscillation of the membrane. A reduced spacing between the electrodes 430, 440 allows operation at lower voltages. In the following description ‘positive’ and ‘negative’ voltages are used to indicate that the electric field in the piezoelectric material is parallel or anti-parallel to the poling direction, respectively.

The sensor 400 includes a membrane 410 formed on a substrate which is removed after formation of the sensor 400 to allow movement of the membrane 410. Besides removing the substrate underneath the membrane (bulk micro-machining), a sacrificial layer process could be applied where a sacrificial layer on the substrate is processed underneath the membrane. This sacrificial layer is etched away to realize the moveable membrane.

Piezoelectric material 420, 420′ is formed on the membrane 410 which, for example, may be patterned if desired to increase performance. Further, a pair of electrodes 430, 440, 430′, 440′ is formed over respective piezoelectric regions 420, 420′ of the patterned piezoelectric material.

As shown in FIG. 4A, when a positive voltage is applied to the inner edge electrode 440, 440′, and a negative voltage is applied to the outer edge electrode 430, 430′, which may alternatively be grounded, elongation 450 of the piezoelectric layers results in a downward bending 460 of the membrane stack, as shown in FIG. 4B. Reversing the polarity of the voltages applied to the electrodes pairs 430, 440 and 430′, 440′, bends the membrane stack upward. Voltage pulses or any alternating current (AC) signals applied to the piezoelectric layers create ultrasonic waves that may be reflected from objects for detection thereof.

The operating principle of a membrane transducer is depicted in FIG. 4B, where a fundamental bending mode is shown. A displacement 404 of the membrane results in bending of the sections 401, 401′ and 402. The sections 403 remain almost unstrained. Piezoelectric actuation is used to bend one or several curved sections 401, 401′, or 402.

If desired the pair of electrodes, instead of being on one side, e.g., on the top side of the piezoelectric material, may be on both sides, e.g., to sandwich the piezoelectric material. In this case, voltage is provided across top and bottom electrode pairs.

The basic module of the piezoelectric thin film transducers is a stack of thin film membranes, as shown by reference numeral 410 in FIG. 4A, respectively. Illustratively, the membrane 410 is formed from silicon nitride, silicon oxide, or combinations of silicon nitride and silicon oxide. The membrane 410 may be deposited for example in a low pressure chemical vapor deposition (CVD) process. On top of the membranes 410, a thin film barrier layer of, e.g., titanium oxide, zirconium oxide or aluminum oxide, may be applied as necessary.

On top of the membrane layer 410 (or on top of the barrier layer when present), a piezoelectric thin film is formed, processed and patterned (if desired) to form the piezoelectric regions 420, 420′. Illustratively, the piezoelectric thin film may be lead titanate zirconate which is either undoped or doped with, e.g., La, but may also be any other piezoelectric material. The piezoelectric layer 420 may be continuous or patterned to match the width of the actuation section (402 in FIG. 4B). A plurality of the transducer elements may be arranged into a one or two dimensional array where the pitch of the elements may be as small as the width of an element (shown as reference numeral 330 in FIG. 3).

As described in connection with FIG. 3, a plurality of elements 310 may be provided in an array 300, which may range from one element to several tens to hundreds or even thousands of elements of the same and/or different size and/or shape. To operate the devices at frequencies of, e.g., 50-450 KHz, the elements are designed with pitches in the order of several hundred micrometers to several thousand micrometers. It should be understood that any other designs, which enable the efficient operation of the transducer at these low frequencies, e.g., circular shaped membranes or elements and any shaped array, are also possible.

The pitch 320 is preferably between about 200 micrometers and about 4000 micrometers. To enable the operation at low voltages and still achieve the desired resonance frequencies of the devices of approximately in the range of 50-450 KHz, a transducer element may have a pitch of 400-1500 μm, which is the design associated with FIG. 4A where interdigital electrodes are formed on only one side of the piezoelectric layer 420.

An array (300 in FIG. 3) of transducer elements may be formed and configured for scanning and beam steering where the elements, having a pitch 320 (FIG. 3) of 400-800 μm, may be connected in parallel, for example.

A voltage signal is applied to the interdigital electrodes 430, 440 (430′, 440′) to provide different sign (or polarity) voltages on adjacent electrodes thus creating an in-plane electric field between the electrodes 430, 440 thus exciting the piezoelectric layer 420 into a longitudinal oscillation in the plane of the piezoelectric layer 420. The change in length of the piezoelectric element excites the membrane 410 into oscillation. The reverse process of converting a mechanical wave (ultrasound) into an electrical signal is also performed by the transducers. In this way, ultrasound waves can be generated and received by transducers of the array 300.

Various modifications may be provided as recognized by those skilled in the art in view of the description herein. For example, actuation electrodes may form a single plate capacitor in the center or at the edges of the membrane. Alternatively, the single plate capacitor may be divided into smaller areas that may be connected in a series configuration to match the operation voltage of the driving circuit. Each of the above transducers, sensors and systems may be utilized in conjunction with further systems. In addition to piezoelectric micro-machined ultrasound transducers, capacitive micro-machined ultrasound transducers may also be employed. In certain applications, different shapes of transducer arrays are desirable. For example, a capacitive membrane ultrasound transducer array formed on slabs of carrier substrates of semiconductor material may be employed. Two slabs of a substrate are separated or connected by a thinner substrate bridge which allows bending. The separated or thinly connected slabs may be positioned along a curved surface resulting in a curved array. The slabs are connected by conductive interconnects that are flexible enough to withstand the degree of curvature. For example, the array 300 shown in FIG. 3 may include at least one thin film flexible ultrasound transducer, configured as at least one omni-directional motion and presence detector. Instead of, or in addition to the flexible ultrasound transducer(s), at least one thin film flexible pyroelectric sensor (or other sensor) may be also provided. The combination of flexible ultrasound and pyroelectric sensors provides less false off's or false alarms, taking advantage of two types of sensors, namely, pyroelectric and ultrasound sensors where the pyroelectric sensor(s) are based on detection of temperature change, e.g., using infrared (IR) signals (that have the disadvantage of needing a line of site for IR signal detection), and where the ultrasound sensor(s) detect ultrasound signals around barriers and do not need a direct line of sight.

Flexibility of the array of ultrasound and/or pyroelectric transducers enables realization of arrays in various shapes. Such flexible transducer arrays may be formed and mounted in any desired shape, e.g., a cone shape on the ceiling. This enables omni-directional transmission and detection of ultrasound and/or IR signals.

Embodiments including a flexible array of transducers of any type of transducer, may be realized, such as ceramic piezoelectric elements, and/or thin film transducers, for example. Ultrasound and pyroelectric transducers may be formed as thin films, using similar processes, and may be formed simultaneously or concurrently together. Piezoelectric material may be used for both generation/transmission and reception/detection of ultrasound and IR signals. Different piezoelectric and pyroelectric materials may also be employed.

Referring to FIG. 5, a method for detecting presence of a living being in emergency conditions is illustratively depicted. In block 502, an alarm condition is detected in a monitored area. In block 506, an ultrasonic transducer array is triggered to scan at least the monitored area to determine a status of the at least monitored area as including a living being in accordance with the alarm condition. The transducer preferably operates at frequencies between about 50 KHz and about 450 KHz, and scans the designated area. The triggering event may be a manual trigger, a temperature trigger, a smoke trigger or any other triggering mechanism. The trigger may be initiated remotely or by the device where the transducer array is located (e.g., a smoke detector).

In block 510, the status that the monitored area includes the living being and a location of the living being is reported to personnel, e.g., rescue workers responding to the alarm condition. The status may be reported on a portable device to alert responding personnel of the presence and location of a living being remaining in a building. The reporting may include reporting to a central station configured to collect the results of the scan. The status may be reported to emergency personnel upon their arrival at the monitored area. The results are mapped in block 512 so that they may be employed to find potential victims. The information obtained may be employed to provide accurate information regarding the whereabouts of living beings in the area of the transducer array. This information can be employed to quickly locate and save potential victims. In addition, this information reduces the risk to rescue workers, who will have less manual searching to perform.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) no specific sequence of acts is intended to be required unless specifically indicated.

Having described preferred embodiments for devices, systems and methods (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the embodiments disclosed herein as outlined by the appended claims. Having thus described the details and particularity required by the patent laws, what is claimed and desired protected by Letters Patent is set forth in the appended claims.

1. A detection device, comprising:
a transducer array (20) located at a designated area and configured to perform an ultrasonic sweep of the area in response to a trigger event, the transducer array being capable of determining a presence of a live being (16) in the area in accordance with the ultrasonic sweep;
a power supply (21) coupled to the transducer array to provide power to the transducer array and to enable the ultrasonic sweep in a power failure; and
a transmitter (23) configured to transmit a result of the ultrasonic sweep to provide a determination of the presence of a live being and the live being's location in the area to personnel responding to an event.

2. The device as recited in claim 1, wherein the transducer array (20) includes a thin-film piezoelectric membrane transducer array.

3. The device as recited in claim 1, wherein the transducer array (20) includes a plurality of transducers configured in an array having a pitch (320) between transducers such that operating frequencies are between about 50 KHz and about 450 KHz.

4. The device as recited in claim 3, wherein the pitch (320) is between about 200 micrometers and about 4000 micrometers.

5. The device as recited in claim 1, wherein the power supply includes at least one of an emergency lighting system (12), and a battery (21).

6. The device as recited in claim 1, wherein transmitter (23) transmits to a portable device (30) configured to wirelessly receive the results of the sweep.

7. The device as recited in claim 6, wherein the portable device (30) is operated by emergency personnel and includes a channel (34) set to receive the results of the sweep to determine whether people or pets are present in a building.

8. The device as recited in claim 1, wherein the transmitter (23) transmits to a central station (22) configured to collect the results of the sweep and report the results to the personnel responding to the event.

9. The device as recited in claim 1, wherein the event is an emergency event and includes at least one of a fire, a break-in and a medical emergency.

10. The device as recited in claim 1, wherein the device includes an in-home smoke detector.

11. The device as recited in claim 1, wherein the transducer array (20) is configured to perform the scan when triggered by the event.

12. A detection system, comprising:
an alarm device (14) disposed in area to detect an alarm event;
a transducer array (20) coupled to the alarm device and configured to perform an ultrasonic sweep of an area in response to the alarm event, the transducer array being capable of determining a presence of a live being in the area as a result of the ultrasonic sweep, the alarm device including an emergency power supply (12) coupled to the transducer array to provide power to the transducer array even during power failure conditions; and
an output device (22, 30) linked to the transducer array, the output device being configured to receive a result of the ultrasonic sweep to provide a determination of the presence of a live being and the live being's location in the area to personnel responding to an event.

13. The system as recited in claim 12, wherein the transducer array (20) includes a thin-film piezoelectric membrane transducer array.

14. The system as recited in claim 12, wherein the transducer array (20) includes a plurality of transducers having a pitch (320) between transducers such that operating frequencies are between about 50 KHz and about 450 KHz.

15. The system as recited in claim 14, wherein the pitch (320) is between about 200 micrometers and about 4000 micrometers.

16. The system as recited in claim 12, wherein the emergency power supply (12) includes one of an emergency lighting system (12) and a battery (21).

17. The system as recited in claim 12, wherein the output device includes a portable device (30) configured to wirelessly receive the results of the sweep.

18. The system as recited in claim 12, wherein the output device is operated by emergency personnel and includes a channel (34) set to receive the results of the sweep to determine whether people or pets are present in a building.

19. The system as recited in claim 12, wherein the output device includes a central station (22) configured to collect the results of the sweep and report the results to the personnel responding to the event.

20. A method for detecting presence of a living being in emergency conditions, comprising:
detecting (502) an alarm condition in a monitored area;
triggering (506) an ultrasonic transducer array to scan at least the monitored area to determine a status of the at least monitored area as including a living being in accordance with the alarm condition; and
reporting (510) a status that the at least monitored area includes the living being and a location of the living being to personnel responding to the alarm condition.

21. The method as recited in claim 20, wherein the transducer operates at frequencies between about 50 KHz and about 450 KHz.

22. The method as recited in claim 20, wherein reporting (510) includes reporting the status on a portable device (30) to alert responding personnel of the presence and location of a living being remaining in a building.

23. The method as recited in claim 22, wherein reporting (510) includes reporting the status to a central station (22) configured to collect the results of the sweep.

24. The method as recited in claim 23, further comprising providing the status to emergency personnel upon their arrival at the monitored area.
